(19) United States
(12) Patent Application Publication
(10) Pub. No.: US 2009/0173408 A1
(43) Pub. Date: Jul. 9, 2009

(54) Steel Pipe Covered at its Inside Surface with Polyolefin Superior in Durability and Method of Production of Same and Plated Steel Pipe Used for that Covered Steel Pipe

(76) Inventors: Hiroyuki Mimura, Tokyo (JP); Shinichi Funatsu, Tokyo (JP); Kazuto Yamamoto, Tokyo (JP); Yoshihisa Kariyazono, Tokyo (JP); Tetsumi Kondo, Tokyo (JP)

Correspondence Address: KENYON & KENYON LLP, ONE BROADWAY, NEW YORK, NY, 10004, US

(21) Appl. No.: 12/227,732

(22) PCT Filed: May 29, 2007
(86) PCT No.: PCT/JP2007/061256

§ 371 Date: Nov. 24, 2008

(30) Foreign Application Priority Data
May 30, 2006 (JP) 2006-150131

(51) Int. Cl. F16L 9/147

(52) U.S. Cl. 138/143; 138/146

(57) ABSTRACT

A steel pipe covered at its inside surface with a polyolefin superior in durability comprising a steel pipe galvanized at its inside surface and its outside surface with layers containing Al in 0.01 to 60 mass % and covered at its inside surface with a polyolefin pipe through a binder.

### TECHNICAL FIELD

The present invention relates to a steel pipe covered at its inside surface with a polyolefin comprised of a steel pipe galvanized at its inside surface and outside surface and covered at its inside surface with a polyolefin pipe, a method of production of the same, a galvanized steel pipe for a steel pipe covered at its inside surface with a polyolefin used for the same, and a method of production of the same.

### BACKGROUND ART

In the past, as steel pipe for waterworks and sewerage, a steel pipe covered at its inside surface with a plastic, comprised of a steel pipe covered at its inside surface with a polyvinyl chloride pipe, a polyethylene pipe, or other plastic pipe, has been used so that the water running through the pipe will not directly contact the steel pipe and the steel pipe will not corrode.

Up to now, several methods of production have been disclosed (see Japanese Patent Publication (A) No. 55-41246, Japanese Patent Publication (A) No. 5-24110, Japanese Patent Publication (A) No. 6-285980, Japanese Patent Publication (A) No. 2003-94522, and Japanese Patent Publication (A) No. 2003-285372).

Japanese Patent Publication (A) No. 55-41246 discloses a method of production of steel pipe covered at its inside surface with polyvinyl chloride comprising coating a binder on an inside surface of a steel pipe and an outside surface of a polyvinyl chloride pipe of an outside diameter slightly smaller than an inside diameter of the steel pipe, inserting said polyvinyl chloride pipe into an inside surface of the steel pipe, heating the whole in a heating furnace to 90 to 130° C. to make the polyvinyl chloride pipe sufficiently soften and expand, closing the two ends of the polyvinyl chloride pipe, charging the pipe with 5 to 10 kg/m² of air under pressure over several seconds to tens of seconds to make the polyvinyl chloride pipe bond with the inside surface of the steel pipe, then cooling.

According to this method of production, it is possible to strongly bond the polyvinyl chloride pipe to the inside surface of the steel pipe.

Japanese Patent Publication (A) No. 5-24110 discloses a method of production comprising heating and pressurizing a polyvinyl chloride pipe coated with a binder to make it bond with an inside surface of a steel pipe during which using a binder with a coefficient of linear expansion not more than 2 times the coefficient of linear expansion of the steel pipe.

According to this method of production, the impact strength of the inside surface covering and the shear bonding strength at 85° C. are improved.

Japanese Patent Publication (A) No. 6-285980 disclose a method of production comprising coating a polyvinyl chloride pipe, cross-linked polyethylene pipe, or other heat expandable plastic pipe obtained by diameter reduction with a hot melt type binder at its outside surface, inserting it into an inside surface of the steel pipe, heating it by an infrared heater to make it expand and bond with the inside surface of the steel pipe, and charging the inside of the heat expandable plastic pipe under pressure with a pressurized fluid to cool it while making it bond with the inside surface of the steel pipe.

According to this method of production, it is possible to heat the metal pipe by a predetermined temperature gradient over the longitudinal direction without being influenced by the outside air flowing into the heating furnace, so it is possible to strongly bond the metal pipe and plastic pipe without allowing interposition of air bubbles between the inside surface of the metal pipe and plastic pipe.

However, when recycling waste steel pipe covered at its inside surface with a polyvinyl chloride pipe as an iron resource, the polyvinyl chloride sometimes produces dioxins and other harmful substances at the time of incineration and causes environmental problems, so a recycling system including an incineration process cannot be employed when recycling waste steel pipe.

To recycle waste steel pipe, there is the method of heating the waste steel pipe to reduce the bonding strength of the polyvinyl chloride pipe, pulling out and separating the polyvinyl chloride pipe when the steel pipe is still in a high temperature state, and processing the steel pipe and polyvinyl chloride pipe after separation in respective recycling systems. However, the work of separating the steel pipe and polyvinyl chloride pipe in the high temperature state is high load work for the worker.

Therefore, steel pipe covered at its inside surface with a polyolefin utilizing as the plastic pipe covering the inside surface a polyolefin pipe with no fear of producing dioxins at the time of recycling waste steel pipe has been developed.

Japanese Patent Publication (A) No. 2003-94522 discloses a method of production comprising inserting into a steel pipe a polyolefin pipe laminated at its outside surface with a hot melt type binder, heating these to at least the crystallization temperature of the polyolefin and at least the melting point of the hot melt type binder, pressurizing the inside of the polyolefin pipe to make it bond with the inside surface of the steel pipe, and holding the inside of the pipe in the pressurized state until the temperature of the polyolefin pipe becomes less than the crystallization temperature even in the following cooling process.

In this method of production, the heating temperature is preferably about the crystallization temperature of the polyolefin plus 30° C. and the melting point of the binder or more, while the pressurizing pressure is preferably 0.05 to 0.5 MPa. In an example using a low density polyethylene pipe and modified polyethylene-based binder, for a crystallization temperature of 120° C., the heating temperature is made 150° C., the pressurizing pressure is made 0.2 MPa, and the pressurized state is held until the temperature of polyethylene in the middle of cooling reaches 100° C.

Further, according to the above method of production, even if immersed in 85° C. hot water for 1 month, the polyolefin layer will not separate from the steel pipe.

Japanese Patent Publication (A) No. 2003-285372 discloses a method of production comprising inserting into a steel pipe a polyolefin pipe laminated at its outside surface with a hot melt type binder, pressurizing the inside surface of the pipe at a temperature of the melting point of the polyolefin pipe or less to make it expand, then heating to at least the melting point of the polyolefin pipe and at least the activation temperature of the binder to make the polyolefin pipe bond to the inside surface of the steel pipe and holding the inside of the pipe in the pressurized state until the temperature of the polyolefin pipe becomes less than the crystallization temperature even in the following cooling step.

In an example using a low density polyethylene pipe (melting point 120° C.) and modified polyethylene-based binder (activation temperature 140° C.), the pipe is pressurized to 5 MPa at ordinary temperature, then heated to 150° C., then held in the pressurized state until the temperature of the polyethylene in the middle of cooling becomes 100° C. or less.

In an example using a low density polyethylene pipe (melting point 120° C.) and modified polyethylene-based binder (activation temperature 140° C.), the pipe is pressurized at 60° C. to 4 MPa, then heated to 150° C., then held in the pressurized state until the temperature of the polyethylene in the middle of the cooling becomes 100° C. or less.

Further, according to this method of production, the inside surface of the polyolefin pipe is heated to expand at a temperature below the melting point of the inside surface, so it is possible to make the unevenness of the thickness at the inside surface covering smaller.

However, with the steel pipe covered at its inside surface with a polyolefin produced by the above conventional method, in artic regions where water pipes are repeatedly subject to freezing/thawing, the polyolefin pipe covering the inside surface of the steel pipe sometimes separates from the steel pipe.

Further, when it is necessary to prevent corrosion of the outside surface of the steel pipe, it is known that if using as the steel pipe a galvanized steel pipe hot dip galvanized at its inside and outside surfaces, the waterproof adhesion between the polyolefin pipe and galvanized layer deteriorates in the state with the inside of the steel pipe filled with warm water.

For this reason, when using a polyolefin pipe as the plastic pipe covering the inside surface of the steel pipe, it is required to improve the separation resistance and waterproof adhesion and raise the durability of the steel pipe.

As a method of providing a hot dip galvanized steel pipe for a steel pipe covered at its inside surface with a polyolefin with good durability, it may be considered to weld the hot dip galvannealed steel plate (GA) being widely used as automobile steel sheet superior in paint adhesion by the electroresistance welding method to produce a hot dip galvanized steel pipe.

However, in this case, there is the problem that the iron-zinc alloy layer is exposed at the surface-most layer of the outside surface of the steel pipe and the luster of the surface-most layer becomes remarkably inferior to the luster of the surface-most layer of the hot dip galvanized steel pipe having a pure zinc layer. Further, there is the problem that the plating layer disappears at the inside and outside surfaces of the weld zone welded by an electroresistance welding method.

Therefore, for a hot dip galvanized steel pipe for a steel pipe covered at its inside surface with a polyolefin, as the plating surface of the outside surface of the steel pipe, a plating surface which is uniform as a whole, beautiful, and lustrous is required. As the plating surface of the inside surface of the steel pipe, a plating surface which is uniform as a whole and superior in paint adhesion is required.

### DISCLOSURE OF THE INVENTION

The present invention has as its object to solve the above problems in the prior art by the provision of a steel pipe covered at its inside surface with a polyolefin resistant to separation of the polyolefin pipe even in an environment where freezing/thawing are repeated or in a state filled with warm water at all times, a method of production of the same, a galvanized steel pipe used for the same, and a method of production of the same.

When covering the inside surface of the galvanized steel pipe by a polyolefin pipe, it is important to secure a high bonding strength at the interface of the galvanized layer and the polyolefin pipe. Therefore, the inventors investigated the causes from the state of separation of the polyolefin pipe.

As a result, the inventors came up with the idea that in the prior art, the bonding strength did not become sufficiently large enough to be able to withstand the shrinkage stress occurring in a polyolefin pipe by the repeated freezing/thawing phenomenon and as a result separation easily occurred.

Further, in addition, the inventors came up with the idea that a polyolefin pipe has a larger shrinkage and expansion compared with a polyvinyl chloride pipe, so residual stress remains inside the polyolefin pipe before and after hot pressing and as a result the bonding strength falls and separation occurs along with repeated freezing/thawing.

The inventors intensively studied the means for solution of the above prior art under the above thinking. As a result, they obtained the following discovery.

(x) if adding Al in an amount of 0.01 to 60 mass % to the galvanized layer of the galvanized steel pipe, it is possible to improve the bonding strength at the interface of the galvanized layer and the polyolefin pipe,

(y) when heating and pressurizing the polyolefin pipe and using it to cover the inside surface of the galvanized steel pipe, if making the temperature for letting out the sealing air (or nonoxidizing gas) suitable, it is possible to greatly reduce the stress remaining at the inside of the polyolefin pipe, and

(z) due to the synergistic action of (x) and (y), even in an environment where freezing/thawing are repeated, the polyolefin pipe will not separate even in a state in contact with warm water over a long time.

The present invention was made based on this discovery and has as its gist the following:

(1) A steel pipe covered at its inside surface with a polyolefin superior in durability comprised of a steel pipe galvanized at its inside surface and its outside surface by layers containing Al in 0.01 to 60 mass % and covered at its inside surface with a polyolefin pipe through a binder.

(2) A steel pipe covered at its inside surface with a polyolefin superior in durability as set forth in (1) wherein an inside surface of said steel pipe is a primed inside surface.

(3) A steel pipe covered at its inside surface with a polyolefin superior in durability as set forth in (2) wherein said priming is coating by an epoxy primer.

(4) A steel pipe covered at its inside surface with a polyolefin superior in durability as set forth in any one of (1) to (3) wherein said steel pipe is an Si-killed steel pipe or an Si—Al-killed steel pipe.

(5) A steel pipe covered at its inside surface with a polyolefin superior in durability as set forth in (4) wherein said steel pipe is a steel pipe comprised of an Si-killed steel pipe or an Si—Al-killed steel pipe galvanized at its outside surface by a layer containing Al in 0.01 to 0.3 mass %.

(6) A steel pipe covered at its inside surface with a polyolefin superior in durability as set forth in any one of (1) to (5) wherein said polyolefin pipe is a polyethylene pipe and said binder is a maleic anhydride-modified polyethylene or an ethylene-maleic anhydride-acrylic acid ester three-way copolymer.

(7) A method of production of a steel pipe covered at its inside surface with a polyolefin superior in durability comprising:

(a) inserting into a steel pipe galvanized at its inside surface and its outside surface with layers containing Al in 0.01 to 60 mass % a polyolefin pipe laminated at the outside surface with a binder,

(b) sealing air or a nonoxidizing gas under pressure inside said polyolefin pipe,

(c) heating said steel pipe as a whole to finally a melting point of the polyolefin or more, then

(d) letting out the sealed in air or nonoxidizing gas when said temperature of the steel pipe falls to below the melting point of the polyolefin.

(8) A method of production of a steel pipe covered at its inside surface with a polyolefin superior in durability as set forth in (7) wherein said steel pipe is a steel pipe primed at its inside surface.

(9) A method of production of a steel pipe covered at its inside surface with a polyolefin superior in durability as set forth in (8) wherein said priming is coating by an epoxy primer.

(10) A method of production of a steel pipe covered at its inside surface with a polyolefin superior in durability as set forth in any one of (7) to (9) wherein said steel pipe is an Si-killed steel pipe or an Si—Al-killed steel pipe.

(11) A steel pipe covered at its inside surface with a polyolefin superior in durability as set forth in (10) wherein said steel pipe is a steel pipe comprised of an Si-killed steel pipe or an Si—Al-killed steel pipe galvanized at its outside surface with a layer containing Al in 0.01 to 0.3 mass %.

(12) A method of production of a steel pipe covered at its inside surface with a polyolefin superior in durability as set forth in any one of (7) to (11) comprising, at said (d), letting out the sealed in air or nonoxidizing gas when the temperature of the steel pipe falls from a melting point of the polyolefin by at least 55° C.

(13) A method of production of a steel pipe covered at its inside surface with a polyolefin superior in durability as set forth in any one of (7) to (12) wherein said polyolefin pipe is a polyethylene pipe and said binder is a maleic anhydride-modified polyethylene or an ethylene-maleic anhydride-acrylic acid ester three-way copolymer.

(14) A hot dip galvanized steel pipe for a steel pipe covered at its inside surface with a polyolefin comprised of a galvanized steel pipe as set forth in any one of (1) to (6) wherein a surface-most layer of an outside surface plating is a galvanized layer containing Al in 0.01 to 60 mass % and a surface-most layer of an inside surface plating is a plating layer with an iron-zinc alloy layer containing Fe in 6 mass % or more accounting for 40% or more of the area.

(15) A method of production of a hot dip galvanized steel pipe for a steel pipe covered at its inside surface with a polyolefin comprising galvanizing a steel pipe at its inside surface and its outside surface with a layer containing Al in 0.01 to 60 mass %, after that, removing the plating surface-most layer of said steel pipe inside surface by a wire brush etc., and exposing the iron-zinc alloy layer containing Fe in 6 mass % or more.

According to the present invention, there is resistance to separation of the polyolefin pipe covering the inside surface even in an environment where freezing/thawing repeatedly occurs or in a state in contact with warm water over a long period. Therefore, the present invention can provide a steel pipe covered at its inside surface with a polyolefin provided with enough durability to enable use over a long time in an artic region.

### BRIEF DESCRIPTION OF THE DRAWINGS

FIG. 1 shows an embodiment of a steel pipe covered at the inside surface with a polyolefin of the present invention.

FIG. 2 is a view showing another embodiment of a steel pipe covered at the inside surface with a polyolefin of the present invention.

FIG. 3 is a view showing the state of inserting inside a galvanized steel pipe a polyolefin pipe laminated at its outside surface with a binder, then sealing air or a nonoxidizing gas inside the polyolefin pipe under pressure.

FIG. 4 is a view showing an example of the relationship between the temperature and the specific volume of polyethylene.

FIG. 5 is a view showing an example of the relationship between the coefficient of linear expansion and temperature of polyethylene.

FIG. 6 is a view showing an example of the relationship between the coefficient of linear thermal expansion and temperature of polyethylene.

FIG. 7 is a view showing an example of the relationship between the shrinkage force of a polyethylene pipe and an internal pressure release temperature.

FIG. 8 is a view showing another embodiment of a steel pipe covered at its inside surface with a polyolefin of the present invention.

FIG. 9 is a view showing still another embodiment of a steel pipe covered at its inside surface with a polyolefin of the present invention.

### BEST MODE FOR CARRYING OUT THE INVENTION

The present invention will be explained in detail next based on the drawings.

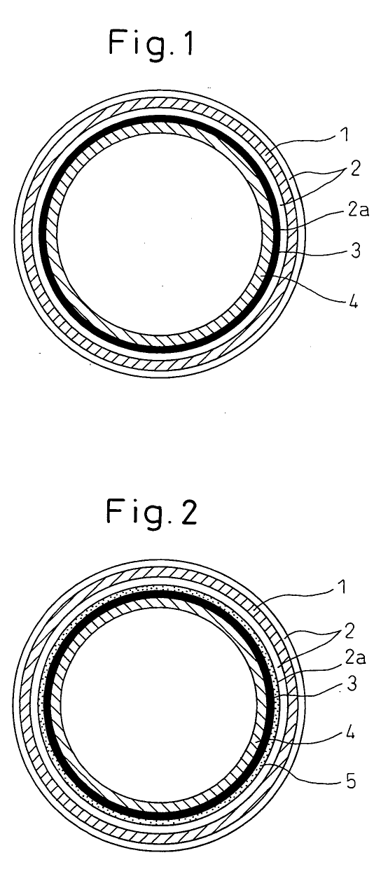

FIG. 1 and FIG. 2 show the cross-section structures of steel pipes covered at their inside surfaces with a polyolefin (steel pipes of the present invention) of the present invention.

FIG. 1 shows a cross-sectional structure of a steel pipe 1 galvanized at its inside surface and outside surface with layers 2 containing Al in 0.01 to 60 mass % and covered at the inside surface 2a of the galvanized steel pipe with a polyolefin pipe 4 through a binder 3.

FIG. 2 shows a cross-sectional structure of a steel pipe 1 galvanized at its inside surface and outside surface with layers 2 containing Al in 0.01 to 60 mass % and coated at the inside surface 2a of the galvanized steel pipe with an epoxy primer 5, then cured and covered with a polyolefin pipe 4 through a binder 3.

In the steel pipe of the present invention, as the steel pipe 1 to be galvanized, it is possible to use a general steel pipe produced using ordinary carbon steel, but if considering the resistance to separation of the galvanized layer itself from the steel pipe, the steel pipe for galvanization is preferably Si-killed steel or Si—Al-killed steel.

The galvanized layers given to the inside surface and the outside surface of the steel pipe 1 have to contain Al in 0.01 to 60 mass %. If the Al in a galvanized layer is less than 0.01 mass %, the polyolefin pipe will easily separate due to repeated freezing/thawing or the state filled with warm water, so the lower limit of the Al is made 0.01 mass %.

The Al in the galvanized layer is preferably high in terms of improving the corrosion resistance of the steel pipe, but if the Al exceeds 60 mass %, the polyolefin pipe will easily separate due to repeated freezing/thawing or the state filled with warm water, so the upper limit of the Al is made 60 mass %.

Note that in the case of using an Si-killed steel pipe or an Si—Al-killed steel pipe, giving the outside surface a galvanized layer containing Al in 0.01 to 0.3 mass % is preferable.

For a galvanized steel pipe, before use, it is necessary to confirm if any white rust or other rust obstructing adhesion of the polyolefin pipe and galvanized layer has occurred.

When the inside surface of the galvanized steel pipe suffers from white rust or other rust, to secure adhesion with the polyolefin pipe, the rust must be removed by a wire brush etc. to clean the surface of the galvanized layer.

By just removing the rust from the surface of the galvanized layer, the polyolefin pipe becomes resistant to separation in an environment of repeated freezing/thawing or filled with warm water, but to improve the resistance to separation of the polyolefin pipe more, it is preferable to prime the inside surface of the galvanized steel pipe (surface of the galvanized layer).

As the priming, it is possible to polish clean the plating surface, lightly pickle the plating surface, etc., but if coating the inside surface of the galvanized steel pipe with an epoxy primer, heating and curing it, then covering this with a polyolefin pipe, the resistance to separation of the polyolefin pipe is remarkably improved.

As the epoxy primer, a commercially available liquid epoxy primer or powder epoxy primer can be used, but from the viewpoint of the environment and health in the production plants, a powder epoxy primer is preferable.

The coating thickness is not particularly limited, but in the case of a liquid epoxy primer, 30 to 70 μm is preferable, while in the case of a powder epoxy primer, 50 to 250 μm is preferable.

In the steel pipe of the present invention, as the polyolefin pipe, a pipe produced by polyethylene, cross-linked polyethylene, polypropylene, ethylene-propylene copolymer, etc. can be used, but if using the steel pipe of the present invention for a water pipe, a polyethylene pipe is preferable from the viewpoint of economy.

In this case, as the polyethylene, from the viewpoint of corrosion prevention, high density polyethylene with a small coefficient of permeation of steam or oxygen is preferable.

As the binder laminated on the outside surface of the polyolefin pipe, a maleic anhydride-modified polyethylene, ethylene-maleic anhydride-acrylic acid ester three-way copolymer, etc. may be used.

At the time of laminating the binder, the binder is extruded in advance by a round die etc. to cover and laminate the outside surface of the polyolefin pipe. The thickness of the binder is not particularly limited, but 100 μm or so (80 to 120 μm) is preferable.

Next, the method of production of steel pipe of the present invention (the method of production of the present invention) will be explained with reference to the drawings.

A galvanized steel pipe comprised of a steel pipe 1 galvanized at the inside surface and the outside surface with layers 2 containing Al in 0.01 to 60 mass % is fit inside it with a polyolefin pipe laminated at its outside surface with a binder, then air or a nonoxidizing gas is sealed inside of the polyolefin pipe under pressure.

Further, the inside surface of the galvanized steel pipe comprised of the steel pipe 1 galvanized at the inside surface and the outside surface with layers 2 containing Al in 0.01 to 60 mass % 2 is primed, then the inside of the steel pipe is fit inside it with a polyolefin pipe laminated at its outside surface with a binder, then air or a nonoxidizing gas is sealed inside of the polyolefin pipe under pressure.

When inserting a polyolefin pipe on which a binder is laminated inside a galvanized steel pipe, to perform the insertion work smoothly, a polyolefin pipe with an outside diameter smaller than the inside diameter of the galvanized steel pipe is used.

However, if the clearance between the inside surface of the galvanized steel pipe and the polyolefin pipe is too large, even if the polyolefin pipe expands, the polyolefin pipe will not adhere to the inside surface of the galvanized steel pipe or even if adhering, will easily separate, so the outside diameter of the polyolefin pipe is suitably selected considering the inside diameter of the galvanized steel pipe, the expansion rate of the polyolefin pipe, and the resistance to separation after adhesion.

According to test calculations and experimental findings of the inventors, the outside diameter of the polyolefin pipe is preferably the inside diameter of the galvanized steel pipe x (0.93 to 0.95) from the viewpoint of securing sufficient resistance to separation.

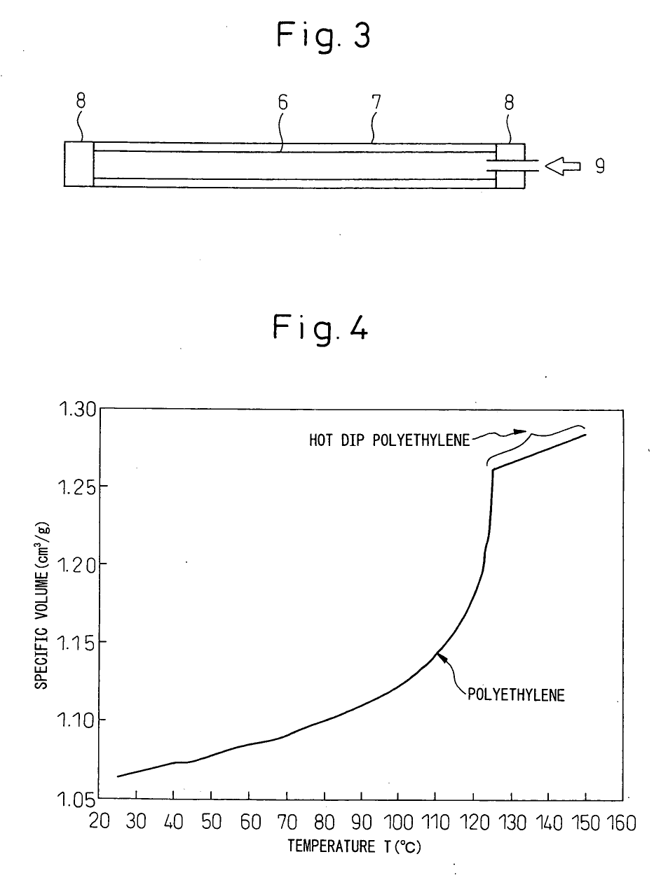

FIG. 3 shows the mode of inserting inside the galvanized steel pipe 7 the polyolefin pipe 6 laminated at its outside surface with a binder, then sealing air or a nonoxidizing gas inside the polyolefin pipe under pressure.

As shown in FIG. 3, the two ends of the polyolefin pipe 6 are closed by caps 8, air or nonoxidizing gas 9 is charged under pressure from one of the caps 8, then the cap 8 is closed to seal the pressurized air or nonoxidizing gas inside the polyolefin pipe 6. In this sealed state, the galvanized steel pipe is placed in a heating furnace where finally the steel pipe as a whole is heated to the melting point of the polyolefin pipe 6 or more.

The nonoxidizing gas sealed under pressure inside the polyolefin pipe is not limited to a specific gas, but an inert gas of argon or nitrogen, carbon dioxide gas, etc. is preferable. If considering the work efficiency and economy, air is more preferred.

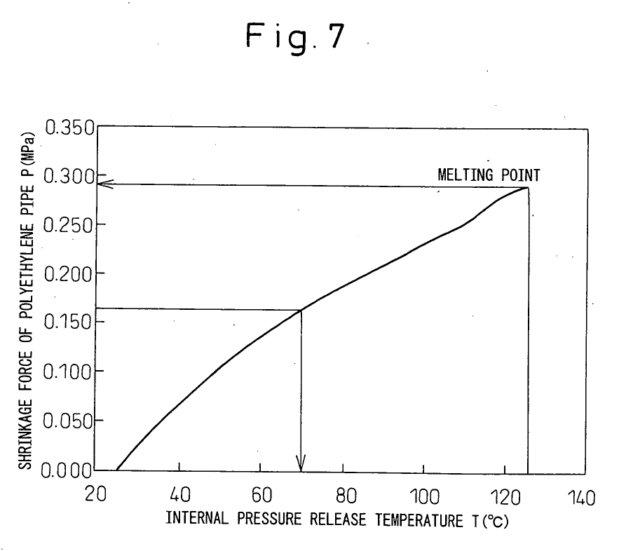

The sealing gas has the action of causing the polyolefin pipe to expand and making it adhere to the inside surface of the galvanized steel pipe (plating surface) when heating the polyolefin pipe to the melting point or more, so the pressure at the time of sealing should be a pressure enabling the pressure causing this action at the melting point of the polyolefin pipe (according to the later explained FIG. 7, at least 0.3 MPa) and is not limited to a specific pressure range.

Note that according to the calculations of the inventors, the pressure at the time of sealing is sufficiently 0.05 MPa or so.

The upper limit of the pressure at the time of sealing is not particularly limited, but if the pressure making the polyolefin pipe expand and adhere to the inside surface of the galvanized steel pipe (plating surface) at the melting point of the polyolefin pipe becomes excessive, the caps 8 attached to the ends of the polyolefin pipe detach, so in practice the pressure should be one where the caps 8 do not come off.

The pressure at the time of actual sealing is preferably 0.3 to 0.6 MPa where a stable pressure is obtained by a commercially available compressor and the caps will not detach.

The galvanized steel pipe 7 as a whole is finally heated to the melting point of the polyolefin or more to make the polyolefin pipe 6 expand and press bond with the inside wall of the galvanized steel pipe 7, then is cooled while applying the internal pressure. When the galvanization temperature of the steel pipe drops to below the melting point of the polyolefin, the air 9 or nonoxidizing gas in the polyolefin pipe is let out and the caps 8 at the two ends are detached.

In the method of production of the present invention, finally, it is important to heat the steel pipe as a whole to the melting point of the polyolefin or more so as to make the polyolefin pipe adhere to the inside surface of the steel pipe by a uniform thickness. Note that the mode of heating from ordinary temperature to the final heating may be the usual mode of heating.

The heating temperature is suitably set considering the melting point of the polyolefin pipe and the heating time until the heating time is reached.

For example, when using as the polyolefin pipe a pipe of high density polyethylene with a density of 0.94, as shown in FIG. 4, since the melting point of polyethylene is 125° C., the heating temperature need only be 125° C. or more, but a long time is required until finally the polyethylene pipe as a whole melts, so from the viewpoint of shortening the heating time and improving the productivity and economy, the pipe is preferably heated to 140 to 170° C., more preferably 155 to 165° C.

Due to the heating of the galvanized steel pipe, the air or nonoxidizing gas sealed inside the polyolefin pipe expands, the binder laminated on the outside surface of the polyolefin pipe melts, and the polyolefin pipe is strongly bonded to the inside surface of the galvanized steel pipe.

After the polyolefin pipe is strongly bonded to the inside surface of the galvanized steel pipe, the galvanized steel pipe starts to be cooled. Further, when the galvanization temperature of the steel pipe falls below the melting point of the polyolefin pipe, the air or nonoxidizing gas sealed inside the polyolefin pipe is let out to release the internal pressure.

If releasing the internal pressure, the polyolefin pipe tries to shrink. Further, it tries to shrink in the cooling process as well. The polyolefin pipe is bonded by a binder to the galvanized steel pipe, so residual stress occurs at the pipe walls after cooling prompting the polyolefin pipe to separate.

From the viewpoint of improving the durability of the galvanized steel plate, the residual stress generated is preferably as small as possible. In the method of production of the present invention, it is important to release the internal pressure at a temperature able to suppress to a minimum the generation of residual stress.

For example, as shown in FIG. 4, polyethylene shrinks in volume along with a drop in temperature and rapidly shrinks from right under the melting point. For this reason, if letting out the sealing air or nonoxidizing gas in the temperature region where the volume rapidly shrinks in the cooling process of polyethylene pipe, the internal pressure is released and the polyethylene pipe tries to shrink.

On the other hand, the polyethylene pipe is bonded by the binder to the galvanized steel pipe, so after the release of the internal pressure, residual stress trying to make the polyethylene pipe separate occurs at the pipe walls.

A polyethylene pipe shrinks even in the cooling process, so the temperature for releasing the internal pressure is ideally ordinary temperature (25° C. or so), but the pipe takes time to cool, so this is not economical.

To shorten the cooling time, it may be considered to water cool the outside surface of the galvanized steel pipe, but there is the risk of occurrence of white rust at the outside surface of the galvanized steel pipe, so water cooling the outside surface is not a wise course.

The inventors ran tests using high density polyethylene pipe (melting point 125° C.) with a density of 0.94. According to the results, if letting out the sealing air or nonoxidizing gas and ending the pressurization at the point of time when the temperature of the polyethylene pipe drops to 70° C., that is, at the point of time when it falls from the melting point of polyethylene (125° C.) by 55° C., good results are obtained.

The reason is guessed to be as follows:

The shrinkage stress σ occurring due to the temperature drop of polyethylene can be found by the following formula:

$$σ = {\int }_{{T}_{1}}^{{T}_{2}} E ( T ) \{ α ( T ) - α s ( T ) \} d T$$

where,

σ: shrinkage stress occurring in polyethylene due to temperature drop

T₁, T₂: temperatures before and after cooling of polyethylene and steel pipe

E(T): coefficient of linear thermal expansion of polyethylene

α(T), αs(T): coefficients of linear expansion of polyethylene and steel pipe

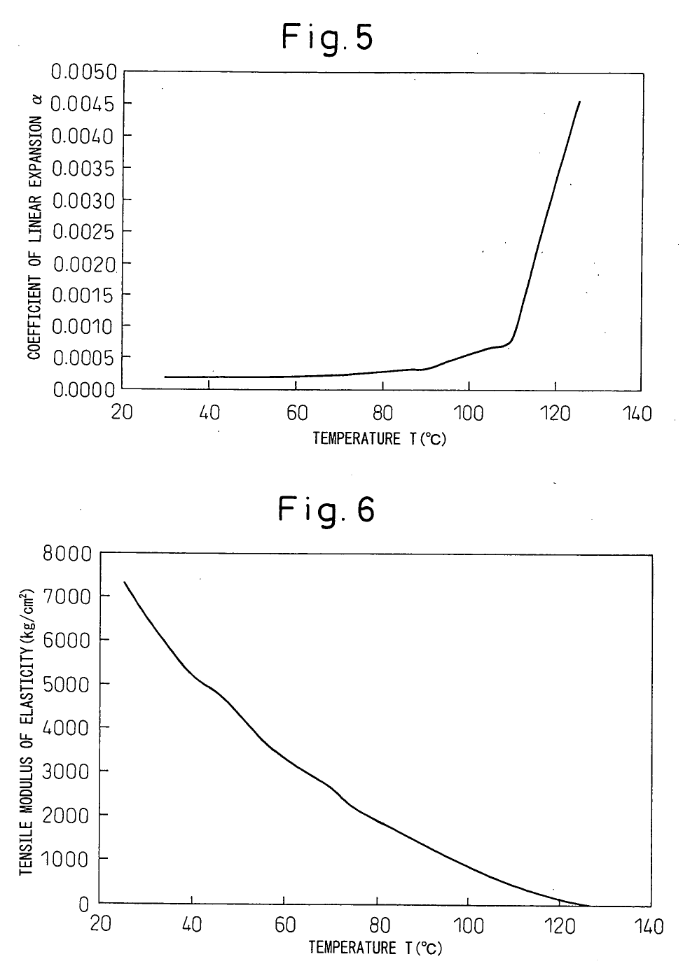

Here, the coefficient of linear expansion a(T) of polyethylene is a function of the temperature T. With high density polyethylene of a density of 0.94, it is as shown in FIG. 5. The coefficient of linear expansion αs(T) of steel pipe is a sufficiently small 1/30 to 1/50 of the coefficient of linear expansion of polyethylene, so can be omitted.

Further, the coefficient of linear thermal expansion E(T) of the polyethylene is also a function of the temperature T. With high density polyethylene of a density of 0.94, it is as shown in FIG. 6.

If releasing the internal pressure of the polyethylene pipe when the temperature drops from right below the melting point of polyethylene to each temperature, shrinkage stress occurs at the walls of the polyethylene pipe from each temperature to ordinary temperature corresponding to the temperature difference.

The shrinkage stress can be approximately found by the following formula for summation from the temperature at the time of releasing the internal pressure of the polyethylene pipe for each stage of difference of the temperature until ordinary temperature:

$$α = {\sum }_{i = 1}^{i = n} {E}_{i} ( T ) \cdot α ( T ) \cdot ( {T}_{i + 1} - {T}_{i} )$$

The shrinkage force P occurring at a polyethylene pipe can be found by the following formula:

$$P = 2 \cdot t \cdot σ / D = ( 2 t / D ) \cdot {\sum }_{i = 1}^{i = n} {E}_{i} ( T ) \cdot α ( T ) \cdot ( {T}_{i + 1} - {T}_{i} )$$

where,

t: thickness of polyethylene pipe

D: outside diameter of polyethylene pipe before release of internal pressure

If finding the relationship between the temperature T for releasing the internal pressure and the shrinkage force P occurring at the polyethylene pipe from the coefficient of linear expansion of FIG. 5 and the coefficient of linear thermal expansion of FIG. 6 based on the above formula for a high density polyethylene pipe of a density of 0.94, the relationship shown in FIG. 7 is obtained.

If based on the relationship shown in FIG. 7, if releasing the internal pressure when the temperature T is the melting point or right under it, a large shrinkage force P occurs at the polyethylene pipe and the bonding force at the interface between the polyethylene pipe and galvanized steel pipe becomes smaller by an amount corresponding to the shrinkage force P. As a result, it is believed that the polyethylene pipe separates with repeated freezing/thawing or in the state filled with warm water.

However, if the temperature T for releasing the internal pressure is a lower temperature, the shrinkage force P occurring at the polyethylene pipe becomes smaller and the drop in bonding strength at the interface of the polyethylene pipe and galvanized steel pipe due to this shrinkage force P becomes small, so it is believed that no separation of the polyethylene pipe even with repeated freezing/thawing or a state filled with warm water.

In the case of polyethylene pipe, the critical value of the shrinkage force P at which separation of the polyethylene pipe is not caused is near 0.17 MPa shown in FIG. 7. The internal pressure release temperature T corresponding to this shrinkage force P can be estimated to be 70° C.

From the above, in the method of production of the present invention, it is preferable to let out the sealing air or nonoxidizing gas and end the pressurization at the time when the temperature of the polyolefin pipe falls from the melting point of polyolefin by at least 55° C.

Next, hot dip galvanized steel pipe for steel pipe covered at its inside surface with a polyolefin particularly good in durability of adhesion with a polyolefin and its method of production will be explained.

Usually, if treating steel pipe by hot dip galvanization, the surface-most layer of the inside surface becomes the plating layer mainly comprising zinc, while if the plating layer, as explained above, contains the required amount of Al, it is possible to obtain the durability of adhesion with the required polyolefin.

The inventors engaged in further study and as a result discovered that if a mainly zinc plating layer contains Fe in a predetermined amount, the durability of adhesion with the polyolefin is further improved.

Therefore, the inventors studied intentionally causing the presence or exposure of Fe at the plating layer of the inside surface of the steel pipe.

Usually, if hot dip galvanizing a steel pipe, the Fe diffuses from the steel pipe toward the plating layer, so at the steel pipe side of the plating layer, the Fe concentration becomes higher, while at the plating surface-most layer, the Fe concentration becomes lower.

The inventors utilized the distribution of the Fe concentration at the plating layer and polished clean the plating surface-most layer by a brush etc. to expose an Fe—Zn alloy layer containing Fe in 6 mass % or more.

Further, the inventors succeeded, by this exposure, in further increasing the durability of adhesion of the plating layer and the polyolefin.

In an Fe—Zn alloy layer with an Fe content of less than 6 mass %, the desired level of the durability of the adhesion cannot be secured, so it is necessary to expose the Fe—Zn alloy layer containing Fe in 6 mass % or more.

As the method for exposing the Fe—Zn alloy layer, in addition to the method of polishing it clean using a brush etc., for example, the method of holding the inside surface plating layer at a certain degree of high temperature for a predetermined time to promote the heat dispersion of the Fe and forming a plating layer containing Fe in 6 mass % or more at the surface-most layer is also possible.

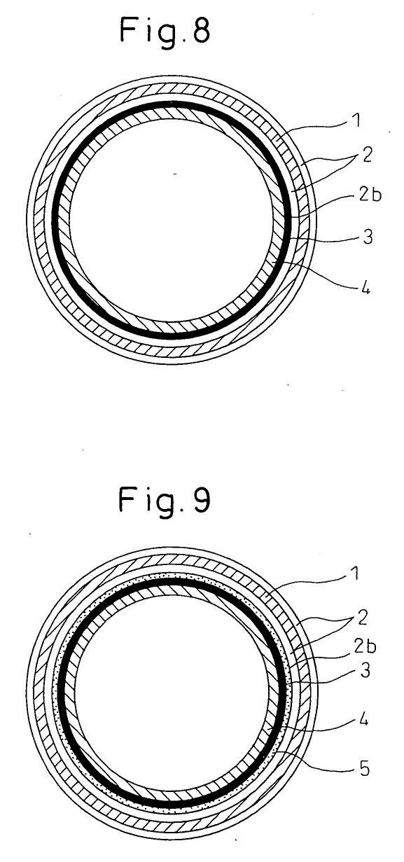

FIG. 8 and FIG. 9 show cross-sectional structures of durable hot dip galvanized steel pipes for a steel pipe covered at its inside surface with a polyolefin of the present invention covered at their inside surfaces with polyolefin (steel pipes of the present invention).

FIG. 8 shows a cross-sectional structure of a steel pipe 1 given hot dip galvanized layers 2 at its inside surface and outside surface, exposing an Fe—Zn alloy layer containing Fe in 6 mass % or more at an inside surface of the galvanized steel pipe, and covered with a polyolefin pipe 4 through a binder 3 at the inside surface.

FIG. 2 shows a cross-sectional structure of a steel pipe 1 given hot dip galvanized layers 2 at its inside surface and outside surface, exposing an Fe—Zn alloy layer containing Fe in 6 mass % or more at an inside surface of the galvanized steel pipe 2b, and coating the inside surface with a epoxy primer 5 and covering it with a polyolefin pipe 4 through a binder 3.

### EXAMPLES

Next, examples of the present invention will be explained, but the conditions of the examples are examples of conditions employed for confirming the workability and advantageous effect of the present invention. The present invention is not limited to this example of conditions. The present invention can employ various conditions so long as not departing from the gist of the present invention and achieving the object of the present invention.

### Example 1

A steel pipe (steel type: Si-killed steel, SGP100A X 6000 mm length) was hot dip galvanized at its inside surface and its outside surface to obtain a galvanized steel pipe. At this time, the content of the aluminum contained in the galvanized layers was changed between 0 to 60 mass %.

The inside surface of the galvanized steel pipe polished clean by a wire brush to remove the white rust. Next, a high density polyethylene pipe with an outside diameter slightly smaller than an inside diameter of this galvanized steel pipe and with a maleic anhydride-modified polyethylene of a thickness of 100 μm laminated at its outside surface was prepared.

The thickness of the high density polyethylene pipe was 2.0 mm, and the melting point was 125° C.

The high density polyethylene pipe was inserted inside the galvanized steel pipe, capped at the two ends as shown in FIG. 3, charged with air under pressure, then heated in a heating furnace to 160° C. to melt the high density polyethylene pipe and press bond it to the inside surface of the galvanized steel pipe.

After that, the galvanized pipe was taken out from the heating furnace and cooled, then the sealing air was let out when the temperature reached 70° C. to obtain a galvanized steel pipe covered at its inside surface with a high density polyethylene pipe (steel pipe of the present invention A).

The steel pipe of the present invention A was cut and tested by a freezing/thawing test and a warm water immersion test.

For the freezing/thawing test, a test piece obtained by cutting the pipe to a length of 150 mm was stood up in a container filled with tap water in a state with about one-third of its length immersed in the water, placed with the container in a −10° C. low temperature bath to make it freeze for 23 hours, then placed in a 60° C. high temperature bath for 1 hour to defrost it. This freezing/thawing operation was defined as 1 cycle and was repeated for 20 cycles.

For the warm water immersion test, a test piece obtained by cutting the pipe to a length of 150 mm was immersed in a container filled with tap water, placed with the container into a 40° C. thermostat bath, and allowed to stand for 1 month.

After the freezing/thawing test and the warm water immersion test, each test piece was investigated for the presence of any separation of the high density polyethylene pipe. The results are shown in Table 2. The results are shown in Table 1.

From Table 1, it will be understood that to prevent separation of the high density polyethylene pipe due to the freezing/thawing or warm water immersion, it is necessary to add 0.01 to 60 mass % of Al in the galvanization.

TABLE 1

Content of aluminum during
galvanization (mass %)

| | 0 | 0.01 | 0.1 | 60 |
|---|---|---|---|---|
| Separation of high density | Yes | No | No | No |
| polyethylene pipe after | | | | |
| freezing/thawing test | | | | |
| Separation of high density | Yes | No | No | No |
| polyethylene pipe after | | | | |
| warm water immersion test | | | | |

### Example 2

A steel pipe (steel type: Si-killed steel, SGP100A X 6000 mm length) was hot dip galvanized at its inside surface and its outside surface to obtain a galvanized steel pipe. At this time, the content of the aluminum contained in the galvanized layers was made 0.01 mass %.

The inside surface of the galvanized steel pipe polished clean by a wire brush to remove the white rust. After that, the surface was primed by electrostatic coating a powder epoxy primer to a thickness of 80 μm, then heated to cure it.

A high density polyethylene pipe with an outside diameter slightly smaller than an inside diameter of this galvanized steel pipe and with a maleic anhydride-modified polyethylene of a thickness of 100 μm laminated at its outside surface was prepared. The thickness of the high density polyethylene pipe was 2.0 mm, and the melting point was 125° C.

The high density polyethylene pipe was inserted inside the galvanized steel pipe, capped at the two ends as shown in FIG. 3, charged with air under pressure, then heated in a heating furnace to 160° C. to melt the high density polyethylene pipe and press bond it to the inside surface of the galvanized steel pipe.

After that, the galvanized pipe was taken out from the heating furnace and cooled, then the sealing air was let out when the temperature reached 70° C. to obtain a galvanized steel pipe covered at its inside surface with a high density polyethylene pipe (steel pipe of the present invention B).

The steel pipe of the present invention A was cut and tested by a freezing/thawing test and a warm water immersion test. For the freezing/thawing test, a test piece obtained by cutting the pipe to a length of 150 mm was stood up in a container filled with tap water in a state with about one-third of its length immersed in the water, placed with the container in a −10° C. low temperature bath to make it freeze for 23 hours, then placed in a 60° C. high temperature bath for 1 hour to defrost it. This freezing/thawing operation was defined as 1 cycle and was repeated for 100 cycles.

For the warm water immersion test, a test piece obtained by cutting the pipe to a length of 150 mm was immersed in a container filled with tap water, placed with the container into a 40° C. thermostat bath, and allowed to stand for 3 months.

After the freezing/thawing test and the warm water immersion test, each test piece was investigated for the presence of any separation of the high density polyethylene pipe. The results are shown in Table 2.

From Table 2, it will be understood that if making the internal pressure applied to the inside surface of the high density polyethylene pipe 0.3 to 0.6 MPa, it is possible to prevent separation of the high density polyethylene pipe due to freezing/thawing or warm water immersion.

TABLE 2

| | Internal pressure of polyethylene pipe | | | |
|---|---|---|---|---|
| | inserted into galvanized steel pipe (MPa) | | | |
| | 0.10 | 0.15 | 0.3 | 0.6 |
| Separation of high density | Yes | Yes | No | No |
| polyethylene pipe after | | | | |
| freezing/thawing test | | | | |
| Separation of high density | Yes | Yes | No | No |
| polyethylene pipe after | | | | |
| warm water immersion test | | | | |

### Example 3

The inside surface and the outside surface of the steel pipe (steel type: Si-killed steel, SGP100A X 6000 mm length) were hot dip galvanized to obtain galvanized steel pipe. At this time, the content of the aluminum included in the galvanization was made 0.01 mass %.

The inside surface of the galvanized steel pipe was polished clean by a wire brush to remove the white rust, was primed by electrostatic coating a powder epoxy primer to a thickness of 80 μm, next was heated to cure it.

A high density polyethylene pipe with an outside diameter slightly smaller than an inside diameter of this galvanized steel pipe and with a maleic anhydride-modified polyethylene of a thickness of 100 μm laminated at its outside surface was prepared. The thickness of the high density polyethylene pipe was 2.0 mm, and the melting point was 125° C.

The high density polyethylene pipe was inserted inside the galvanized steel pipe, capped at the two ends as shown in FIG. 3, sealed with air to an internal pressure of 0.3 MPa, then heated in a heating furnace to 160° C. to melt the high density polyethylene pipe and press bond it to the inside surface of the galvanized steel pipe.

After that, the galvanized pipe was taken out from the heating furnace and cooled. The temperature for letting out the sealing air in the cooling process was changed to obtain a galvanized steel pipe covered at its inside surface with a high density polyethylene pipe (steel pipe of the present invention C).

The steel pipe of the present invention C was cut and tested by a freezing/thawing test and a warm water immersion test. For the freezing/thawing test, a test piece obtained by cutting the pipe to a length of 150 mm was stood up in a container filled with tap water in a state with about one-third of its length immersed in the water, placed with the container in a −10° C. low temperature bath to make it freeze for 23 hours, then placed in a 60° C. high temperature bath for 1 hour to defrost it. This freezing/thawing operation was defined as 1 cycle and was repeated for 100 cycles.

For the warm water immersion test, a test piece obtained by cutting the pipe to a length of 150 mm was immersed in a container filled with tap water, placed with the container into a 40° C. thermostat bath, and allowed to stand for 3 months.

After the freezing/thawing test and the warm water immersion test, each test piece was investigated for the presence of any separation of the high density polyethylene pipe. The results are shown in Table 3.

From Table 3, it will be understood that to prevent separation of the high density polyethylene pipe due to freezing/thawing or warm water immersion, it is preferable to make the temperature for letting out the sealing air inside the high density polyethylene pipe in the cooling process a temperature of 70° C. or less, that is, a temperature of 55° C. or more lower than the melting point (125° C.).

TABLE 3

| Heating end temperature at time of cooling (° C.) | 125 | 100 | 70 | 50 |
|---|---|---|---|---|
| Separation of high density | Yes | Yes | No | No |
| polyethylene pipe after | | | | |
| freezing/thawing test | | | | |
| Separation of high density | Yes | Yes | No | No |
| polyethylene pipe after | | | | |
| warm water immersion test | | | | |

### Example 4

The inside surface and the outside surface of the steel pipe (steel type: Si-killed steel, SGP100A X 6000 mm length) were hot dip galvanized to obtain galvanized steel pipe. At this time, the content of the aluminum included in the galvanization was made 0.01 mass %.

The inside surface of the galvanized steel pipe was polished clean by a wire brush to remove the white rust to prepare a plated steel pipe at which a pure zinc layer is exposed and a plate steel pipe at which an iron-zinc alloy layer with an iron content of 6 A % or more is exposed.

Next, a high density polyethylene pipe with an outside diameter slightly smaller than an inside diameter of this galvanized steel pipe and with a maleic anhydride-modified polyethylene of a thickness of 100 μm laminated at its outside surface was prepared. The thickness of the high density polyethylene pipe was 2.0 mm, and the melting point was 125° C.

The high density polyethylene pipe was inserted inside the galvanized steel pipe, capped at the two ends as shown in FIG. 3, sealed with air under pressure, then heated in a heating furnace to 160° C. to melt the high density polyethylene pipe and press bond it to the inside surface of the galvanized steel pipe.

After that, the galvanized pipe was taken out from the heating furnace and cooled. The sealing air was let out when the temperature reached 70° C. to obtain a galvanized steel pipe covered at its inside surface with a high density polyethylene pipe (steel pipe of the present invention D).

The steel pipe of the present invention D was cut and tested by a freezing/thawing test and a warm water immersion test. For the freezing/thawing test, a test piece obtained by cutting the pipe to a length of 150 mm was stood up in a container filled with tap water in a state with about one-third of its length immersed in the water, placed with the container in a −10° C. low temperature bath to make it freeze for 23 hours, then placed in a 60° C. high temperature bath for 1 hour to defrost it. This freezing/thawing operation was defined as 1 cycle and was repeated for 100 cycles.

For the warm water immersion test, a test piece obtained by cutting the pipe to a length of 150 mm was immersed in a container filled with tap water, placed with the container into a 40° C. thermostat bath, and allowed to stand for 3 months.

After the freezing/thawing test and the warm water immersion test, each test piece was investigated for the presence of any separation of the high density polyethylene pipe. The results are shown in Table 4.

From Table 4, it will be understood that to prevent separation of the high density polyethylene pipe due to freezing/thawing or warm water immersion, it is preferable to expose an iron-zinc alloy layer with an iron content of 6% or more at the inside surface plating.

TABLE 4

| | Surface-most layer of inside surface | |
|---|---|---|
| | plating of steel pipe | |
| | | Iron-zinc alloy |
| | Pure | layer with iron |
| | zinc | content of 6 mass % |
| | layer | or more |
| Separation of high density | Yes | No |
| polyethylene pipe after | | |
| freezing/thawing test | | |
| Separation of high density | Yes | No |
| polyethylene pipe after | | |
| warm water immersion test | | |

### INDUSTRIAL APPLICABILITY

As explained above, according to the present invention, even in an environment where freezing/thawing are repeated and in a state in contact with warm water over a long period of time, resistance is given to separation of the polyolefin pipe covering the inside surface. Therefore, the present invention can provide a steel pipe covered at its inside surface with a polyolefin provided with enough durability to withstand even long term use in an artic location and has a large industrial applicability.

1. A steel pipe covered at its inside surface with a polyolefin superior in durability comprised of a steel pipe galvanized at its inside surface and its outside surface by layers containing Al in 0.01 to 60 mass % and covered at its inside surface with a polyolefin pipe through a binder.

2. A steel pipe covered at its inside surface with a polyolefin superior in durability as set forth in claim 1 wherein an inside surface of said steel pipe is a primed inside surface.

3. A steel pipe covered at its inside surface with a polyolefin superior in durability as set forth in claim 2 wherein said priming is coating by an epoxy primer.

4. A steel pipe covered at its inside surface with a polyolefin superior in durability as set forth in claim 1 wherein said steel pipe is an Si-killed steel pipe or an Si—Al-killed steel pipe.

5. A steel pipe covered at its inside surface with a polyolefin superior in durability as set forth in claim 4 wherein said steel pipe is a steel pipe comprised of an Si-killed steel pipe or an Si—Al-killed steel pipe galvanized at its outside surface by a layer containing Al in 0.01 to 0.3 mass %.

6. A steel pipe covered at its inside surface with a polyolefin superior in durability as set forth in claim 1 wherein said polyolefin pipe is a polyethylene pipe and said binder is a maleic anhydride-modified polyethylene or an ethylene-maleic anhydride-acrylic acid ester three-way copolymer.

7. A method of production of a steel pipe covered at its inside surface with a polyolefin superior in durability comprising:
(a) inserting into a steel pipe galvanized at its inside surface and its outside surface with layers containing Al in 0.01 to 60 mass % a polyolefin pipe laminated at the outside surface with a binder,
(b) sealing air or a nonoxidizing gas under pressure inside said polyolefin pipe,
(c) heating said steel pipe as a whole to finally a melting point of the polyolefin or more, then
(d) letting out the sealed in air or nonoxidizing gas when said temperature of the steel pipe falls to below the melting point of the polyolefin.

8. A method of production of a steel pipe covered at its inside surface with a polyolefin superior in durability as set forth in claim 7 wherein said steel pipe is a steel pipe primed at its inside surface.

9. A method of production of a steel pipe covered at its inside surface with a polyolefin superior in durability as set forth in claim 8 wherein said priming is coating by an epoxy primer.

10. A method of production of a steel pipe covered at its inside surface with a polyolefin superior in durability as set forth in claim 7 wherein said steel pipe is an Si-killed steel pipe or an Si—Al-killed steel pipe.

11. A steel pipe covered at its inside surface with a polyolefin superior in durability as set forth in claim 10 wherein said steel pipe is a steel pipe comprised of an Si-killed steel pipe or an Si—Al-killed steel pipe galvanized at its outside surface with a layer containing Al in 0.01 to 0.3 mass %.

12. A method of production of a steel pipe covered at its inside surface with a polyolefin superior in durability as set forth in claim 7 comprising, at said (d), letting out the sealed in air or nonoxidizing gas when the temperature of the steel pipe falls from a melting point of the polyolefin by at least 55° C.

13. A method of production of a steel pipe covered at its inside surface with a polyolefin superior in durability as set forth in claim 7 wherein said polyolefin pipe is a polyethylene pipe and said binder is a maleic anhydride-modified polyethylene or an ethylene-maleic anhydride-acrylic acid ester three-way copolymer.

14. A hot dip galvanized steel pipe for a steel pipe covered at its inside surface with a polyolefin comprised of a galvanized steel pipe as set forth in claim 1 wherein a surface-most layer of an outside surface plating is a galvanized layer containing Al in 0.01 to 60 mass % and a surface-most layer of an inside surface plating is a plating layer with an iron-zinc alloy layer containing Fe in 6 mass % or more accounting for 40% or more of the area.

15. A method of production of a hot dip galvanized steel pipe for a steel pipe covered at its inside surface with a polyolefin comprising galvanizing a steel pipe at its inside surface and its outside surface with a layer containing Al in 0.01 to 60 mass %, after that, removing the plating surface-most layer of said steel pipe inside surface by a wire brush etc., and exposing the iron-zinc alloy layer containing Fe in 6 mass % or more.
